(19) United States
(12) Patent Application Publication
(10) Pub. No.: US 2011/0215087 A1
(43) Pub. Date: Sep. 8, 2011

(54) AUTOMATIC CONTROL DEVICE FOR AN ELECTRICAL HEATING APPLIANCE

(76) Inventors: Thierry Martinez, Blanes (Girona) (ES); Jean-Louis Carbonnier, Aizenay (FR)

(21) Appl. No.: 13/128,589

(22) PCT Filed: Nov. 10, 2009
(86) PCT No.: PCT/FR2009/052162

§ 371 Date: May 23, 2011

(30) Foreign Application Priority Data
Nov. 10, 2008 (FR) 08 57633
Feb. 24, 2009 (FR) 09 51155

(51) Int. Cl. H05B 1/02

(52) U.S. Cl. 219/494

(57) ABSTRACT

The invention relates to an automatic control device for an electrical heating appliance including a rectifier-inverter, in which one input is connected to the power grid and one output is connected to a circuit including an insulated gate bipolar transistor (IGBT) connected in series with at least one resistor of an electrical heater. There is also an electronic controller, being capable of receiving data from a temperature selector that can be actuated by the user, the selector enabling the user to select the ambient temperature to be reached in the room where the electrical heating appliance is installed. There is also at least one temperature sensor, namely an ambient temperature sensor. The electronic controller controls the insulated gate bipolar transistor by adjusting the intensity of the electric current that flows through at least one resistor of the electrical heating appliance.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The invention relates to an automatic control device for an electrical heating appliance comprising a rectifier-inverter, one inlet of which is connected to the power network and one outlet of which is connected to a circuit including an insulated-gate bipolar transistor (IGBT) connected in series to at least one resistor of an electrical heater, electronic control means designed capable of receiving data from a temperature selector that can be actuated by the user, said selector being designed capable of permitting to select the ambient temperature to be reached in the room where the electrical heating appliance is installed, and at least one temperature sensor, namely an ambient temperature sensor.

The present invention is related in particular to the field of the electrical household heating appliances.

In the further description, by heating appliance will be understood an electrical heating appliance.

2. Description of Related Art Including Information Disclosed Under 37 CFR 1.97 and 37 CFR 1.98

In the field of the heating appliances, the usually known operation is the use of electrical resistors through which passes a current thus transforming the electric energy into heat energy, which is transmitted to the environment by convection. This type of device indeed generally includes an opening in the lower portion, where cool air enters, and an opening in the upper portion, where the air heated by the resistors leaves.

The first heating appliances of this type comprised only an on/off switch, which permitted the user only to switch the heating appliance on or off, without being able to adjust the desired temperature. In order to cope with this drawback, the electrical heating appliances of the next generation included adjusting means permitting, according to the adjustment initiated by the user, to put into operation one or several resistors, while a thermostat permitted to control this operation depending on the ambient temperature.

However, despite the presence of a set value measured by the thermostat, these heating appliances have the major drawback of still having only two operating modes, on the one hand, switched on, in order to reach the set value, starting from a temperature lower than the latter, and, on the other hand, switched off, in order to reach the set value, but this time starting from a temperature higher than the latter. This operating mode causes an important thermal inertia, which has an impact on the comfort of the user.

It is also known to use, in a heating appliance, a sensor for measuring the temperature of the room, in order to try to limit the binary operation on or off of the appliance. Indeed, depending on the latter, the various electrical resistors included in the heating appliance can be switched on or off independently from each other. This control means performs more, because it permits several operating regimes depending on the number of resistors switched on or off in the heating appliance. The sensor permits to follow the set value with a less important inertia than the aforementioned heating appliances, but which is still too high because its operating regime can go from no resistor supplied with current, i.e. the heating appliance is switched off, to all resistors supplied with current.

Finally, it is also known to use a semi-conductor, such as a triac, permitting to control, this time, not the number of resistors supplied with current, but the average value of the current passing through the resistors of the heating appliance. The value of the current is thus changed by the triac, starting from the value measured by a temperature sensor. However, the use of a triac has the drawback of generating transitory currents, which can interfere with the electric power supply network, so that this does not permit to comply with the regulating standards regarding the electrical heating appliances. Therefore, the triac is used only in on/off operation of the triac.

### SUMMARY OF THE INVENTION

The object of the present invention is to cope with the above-mentioned drawbacks by providing an automatic control device for an electrical heating appliance, i.e. the thermal inertia of which is reduced, and in which there is no risk of any interference of the heating appliance with the electric power supply network.

Thus, the present invention consists of an automatic control device for an electrical heating appliance, including a rectifier-inverter the inlet of which is connected to the power network and an outlet of which is connected to a circuit comprising an insulated-gate bipolar transistor (IGBT) connected in series to at least one resistor of an electrical heating appliance, electronic control means designed capable of receiving data from a temperature selector that can be actuated by the user, said selector being designed capable of permitting to select the ambient temperature to be reached in a room in which the electrical heating appliance is installed, and at least one temperature sensor, namely an ambient temperature sensor, wherein said electronic control means are designed capable of acting on said insulated-gate bipolar transistor by controlling the intensity of the electric current flowing through at least one resistor of the electrical heating appliance.

According to yet another feature of the invention, it includes at least one resistor the control of the current intensity of which occurs through pulse width modulation (PWM).

According to yet another feature of the invention, the inlet of the rectifier is provided with a filter designed capable of avoiding the interferences produced by radiofrequency.

Further aims and advantages of the present invention will become clear from the following detailed description, which refers to an exemplary embodiment given by way of an indication and which does not limit same.

The understanding of this description will be facilitated when referring to the attached drawing.

### BRIEF DESCRIPTION OF THE DRAWINGS

FIG. 1 is a schematic illustration of an operational diagram according to the present invention.

FIG. 2 is an electric diagram of the electronic portion of the invention.

### DETAILED DESCRIPTION OF THE DRAWINGS

For simplification's sake, the electrical interconnection, between the elements constituting the automatic control device according to the invention, is made by continuous lines as a single-wire representation.

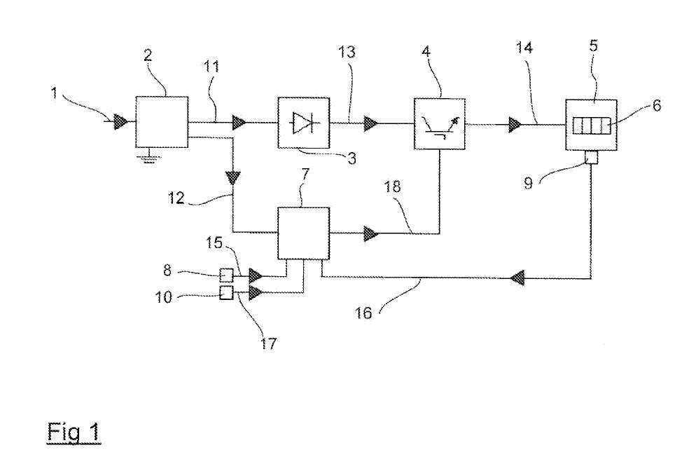

As can be seen in FIG. 1, the device includes an electric power supply 1 connected to the power network, filtering means 2 designed capable of avoiding interferences on the power network. Downstream of these filtering means are arranged correction means 3 and electronic control means 7, via tracks 11 and 12, respectively. The correction means 3 essentially comprise a double-wave rectifier-inverter, which feeds through an insulated-gate bipolar transistor 4 at least one electrical resistor 6 of the electrical heating appliance 5, via tracks 13 and 14. The electronic control means 7 receive the data supplied by the temperature selector 8 via a track 15, the data supplied by a temperature sensor 9 via a track 16 and the data supplied by a room temperature sensor 10 via a track 17.

The electronic control means 7 are provided with software, which is designed so as to control the control of the insulated-gate bipolar transistor 4 by pulse width modulation and the control of the working cycle of the wave supplied by the correction means 3. The result of this control is transmitted to the insulated-gate bipolar transistor 4 via a track 18.

When the system has been connected to the power network, the user selects the set temperature for the electrical heating appliance 5 by means of the temperature selector 8.

This temperature selector can indeed be integrated into the radiator, but it will preferably be offset on a wall or the like.

Thus, through this selector 8, the electronic control means 7 receive the data of the temperature selected by the user, the data of the temperature measured by the ambient temperature sensor 10 and the data of the temperature reached by the electrical heating appliance 5, by the temperature sensor 9.

The electronic control means 7 then establish a pulse width modulation, which fixes the working cycle of the insulated-gate bipolar transistor. This modulation preferably occurs with a 16 kHz frequency carrier.

Thus, the resistor 6 of the electrical heating appliance 5 receives a current intensity that varies between some minimum and maximum values pre-established by the data-processing program of the electronic control means 7, which implies an operation of the electrical heating appliance free of any scaled function of the current intensity, or avoids the switching on and off of the electrical heating appliance with the resulting thermal inertias.

According to a preferred embodiment of the invention, the heating appliance will thus carry out, through the electronic control means 7, by acting on the bipolar transistor 4, a proportional, integral and derived control, in order to quickly arrive close to the value selected by the user. Once the device is close to the set value, to within some tenths of a degree, preferably to within from about ten tenths to about fifteen tenths of a degree, a function of adapting the power transmitted to the heating resistor is performed through the electronic control means 7 depending on the difference in temperature between the set value and the ambient temperature. The power thus transmitted to the heating resistor progressively decreases as the difference in temperature decreases.

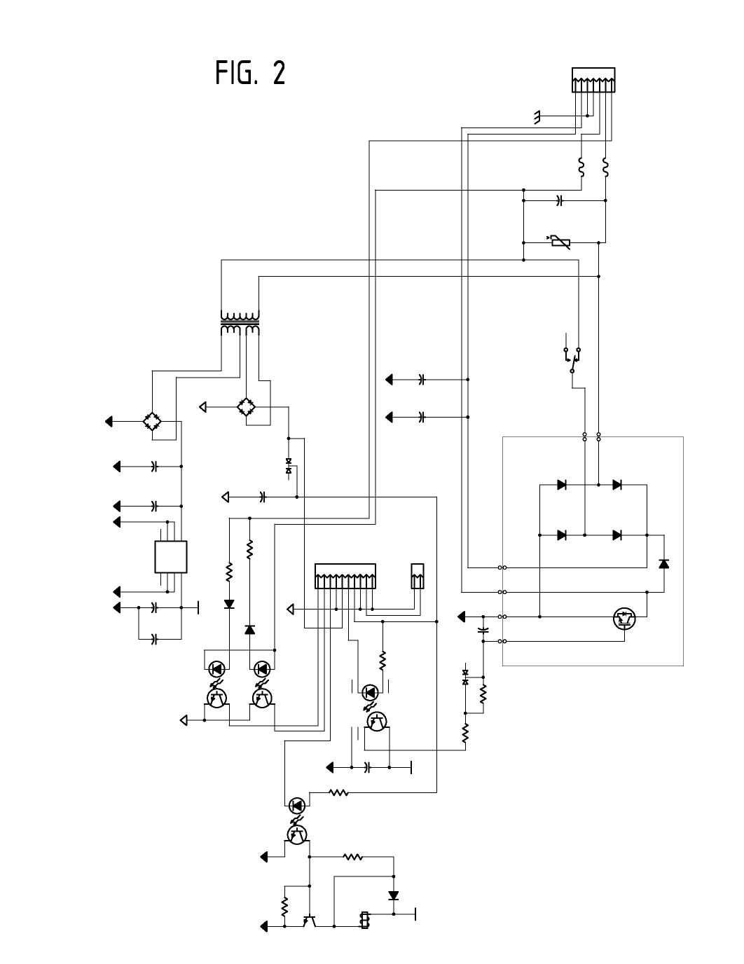

FIG. 2 shows the various electronic elements of the automatic control device. One can see in particular the insulated-gate bipolar transistor, the rectifier mounting as well as all the connections between these various elements.

1. Automatic control device for an electrical heating appliance, said control device comprising:
a rectifier-inverter, having one inlet connected to a power network and an outlet connected to a circuit, said circuit comprising an insulated-gate bipolar transistor (IGBT) connected in series to at least one resistor of an electrical heating appliance;
electronic control means receiving data from a temperature selector that can be actuated by the user, said temperature selector selecting ambient temperature to be reached in a room in which the electrical heating appliance is installed; and
at least one temperature sensor, namely an ambient temperature sensor, wherein said electronic control means acts on said insulated-gate bipolar transistor by controlling intensity of the electric current flowing through at least one resistor of the electrical heating appliance.

2. Device according to claim 1, further comprising:
an additional temperature sensor measuring temperature reached by the device.

3. Device according to claim 1, further comprising:
at least one resistor the control of the current intensity of which occurs by pulse width modulation (PWM).

4. Device according to claim 1, wherein the inlet of the rectifier is provided with a filter means avoiding interferences produced by radiofrequency.
